(19) United States
(12) Patent Application Publication
(10) Pub. No.: US 2016/0229070 A1
(43) Pub. Date: Aug. 11, 2016

(54) Hair Clipper Blade and Manufacture Method Thereof

(71) Applicant: Woody YAO, New Taipei City (TW)

(72) Inventor: Woody YAO, New Taipei City (TW)

(21) Appl. No.: 14/617,299

(22) Filed: Feb. 9, 2015

(51) Int. Cl. B26B 19/38

(52) U.S. Cl. CPC B26B 19/3846; B26B 19/3893

(57) ABSTRACT

A hair clipper blade and a manufacture method thereof, comprising using initially a stamping equipment to stamp out a semi-processed blade having plural round through holes, and then using a grinding wheel to perform cutting operations at the front end of the round through holes in the semi-processed blade toward the round through hole direction thereby forming two corresponding edge parts such that plural tooth units can be created on the movable blade, wherein both the two sides of the front end in each tooth unit include an edge part, and a groove hole is inwardly arc-wise formed between the bottom end of each side in each tooth unit and the bottom end in the adjacent tooth unit.

### BACKGROUND OF THE INVENTION

1. Field of the Invention

The present invention generally relates to a hair clipper blade and a manufacture method thereof; in particular, it relates to processes for machining a thick, solid metallic plate material into a clipper blade such that the fabricated clipper blade structure provides enhanced haircut efficiency and makes the trimmed hair smoother.

2. Description of Related Art

In general, the clipper blade in a hair clipper usually consists of a fixed blade as well as a movable blade overlapped onto the fixed blade such that the movable blade can reciprocatively slide with respect to the fixed blade to trim hair.

To achieve satisfactory trimming effects of the blade and maintain durable and stable performance, manufacturers at present may adopt a thick, solid metallic plate material and use the grinding wheel to cut out a tooth profile such that the tooth profile has a sharp angle and its thickness and structural strength can be retained. Referring to FIG. 1A, a machining diagram illustrates that a grinding wheel 7 is used to perform cutting operations to form the blade 111a; meanwhile, a top view and a cross-section view of the edge part 111 created after the cutting process are respectively shown in FIGS. 1B and 1C. Moreover, FIG. 2A shows the completed clipper blade manufactured through cutting operations by means of the grinding wheel 7 on the thick, solid metallic plate material in prior art; however, such machining operations with a grinder on a thick, solid metallic plate material may generate the following drawbacks:

(a) as shown in FIG. 2A, there exists a V-shaped tooth groove 12 between one blade tooth 11 and another blade tooth 11; consequently, as shown in FIGS. 2B and 3A, upon overlapping the movable blade 1 onto the fixed blade 2 and installing in a hair clipper 3, it can be seen from FIG. 3A that, since the bottom end of the V-shaped tooth groove 12 becomes narrower, when trimming hair, the hair 5 located at the bottom of the V-shaped tooth groove 12 may be reversely pushed out due to jamming condition; therefore, the trimmed hair 6 may be uneven;

(b) besides, as shown in FIG. 3B, because the bottom end of the V-shaped tooth groove 12 becomes narrower, the hair 5 may be more jammed as stretching further in the bottom of the V-shaped tooth groove 12; as such, the hair strings may become more jammed, and upon trimming, it may require more efforts to cut off jammed hair strings, thus resulting in reduced trimming efficiency;

(c) due to a greater friction area at the bottom end, the blade heating issue may become more significant in operation;

(d) such a greater friction area can also lead to greater electric power consumptions;

(e) the above-said machining approach may increase the grinder workload, thus shortening the life span of the grinder and resulting in elevated machining costs.

From the previous descriptions, it can be appreciated that this type of blade tools fabricated from a thick, solid metallic plate material with a grinder to perform machining operations thereon may undesirably exhibit the aforementioned defects. To overcome above-said issues, the present invention proposes to initially perform the stamping operation on a thick, solid metallic plate material and then the cutting operation, such that a groove hole can be inwardly arc-wise formed between the bottom ends of two blade teeth, and the formed groove hole can provide not only the cutting feature, but allow the trimmed hair to be more even, thus enabling increased cutting efficiency, reduced blade friction area, lowered blade heating and electric power consumption as well as decreased grinder workload, thereby offering an optimal solution.

### SUMMARY OF THE INVENTION

The present invention generally relates to a hair clipper blade and a manufacture method thereof, which can perform stamping processes on a thick, solid metallic plate material and then cutting processes thereby reducing grinding operation time and workloads for the grinder equipment as well as grinder tooling consumptions, and the fabricated clipper blade can make trimmed hair more even thus further providing enhanced cutting efficiency and reduced blade heating issue.

A hair clipper blade capable of achieving the aforementioned objectives comprises plural tooth units, in which both the two sides of the front end in each tooth unit include an edge part, and a groove hole is inwardly arc-wise formed between the bottom end of each side in each tooth unit and the bottom end in the adjacent tooth unit.

More specifically, the edge part has a sharp angle.

More specifically, the groove hole is further tapered such that the bottom part of the groove hole has a sharp angle enabling the cutting function.

More specifically, the groove hole is a round groove.

A manufacture method for a hair clipper blade, comprising:

(1) using initially a stamping equipment for stamping operations to form a semi-processed blade having plural round through holes; and

(2) using then a grinding wheel to perform cutting operations at the front end of the round through holes in the semi-processed blade toward the round through hole direction thereby forming two corresponding edge parts and inwardly arc-wise forming a groove hole between each two corresponding edge parts.

More specifically, the edge part has a sharp angle.

More specifically, the groove hole is further tapered such that the bottom part of the groove hole has a sharp angle enabling the cutting function.

More specifically, the groove hole is a round groove.

### BRIEF DESCRIPTION OF THE DRAWINGS

FIG. 1A shows a view for edge machining by means of a grinding wheel on a conventional movable blade.

FIG. 1B shows a top view for the edge part of a conventional movable blade.

FIG. 1C shows a cross-section view along the H-H line in FIG. 1B.

FIG. 2A shows a structure view of a conventional movable blade.

FIG. 2B shows a view for the combination of a conventional movable blade and a fixed blade.

FIG. 2C shows a contact plane view for the combination of a conventional movable blade and a fixed blade.

FIG. 3A shows a view for hair trimming with a conventional hair clipper.

FIG. 3B shows a view for the hair jamming condition within a V-shaped tooth groove of a conventional hair clipper.

FIG. 4 shows a structure view for a non-machined blade used in the blade set of the hair clipper blade and a manufacture method thereof according to the present invention.

FIG. 5 shows a structure view for a partially machined blade used in the blade set of the hair clipper blade and a manufacture method thereof according to the present invention.

FIG. 6 shows a structure view for a completely machined blade used in the blade set of the hair clipper blade and a manufacture method thereof according to the present invention.

FIG. 7 shows a manufacture method flowchart for the hair clipper blade and a manufacture method thereof according to the present invention.

FIG. 8A shows a view for the combination of a movable blade and a fixed blade in the blade set of the hair clipper blade and a manufacture method thereof according to the present invention.

FIG. 8B shows a contact plane view for the combination of a movable blade and a fixed blade in the blade set of the hair clipper blade and a manufacture method thereof according to the present invention.

FIG. 9A shows a hair trimming view for the blade set of the hair clipper blade and a manufacture method thereof according to the present invention.

FIG. 9B shows a view for the hair loose condition within the groove hole in the blade set of the hair clipper blade and a manufacture method thereof according to the present invention.

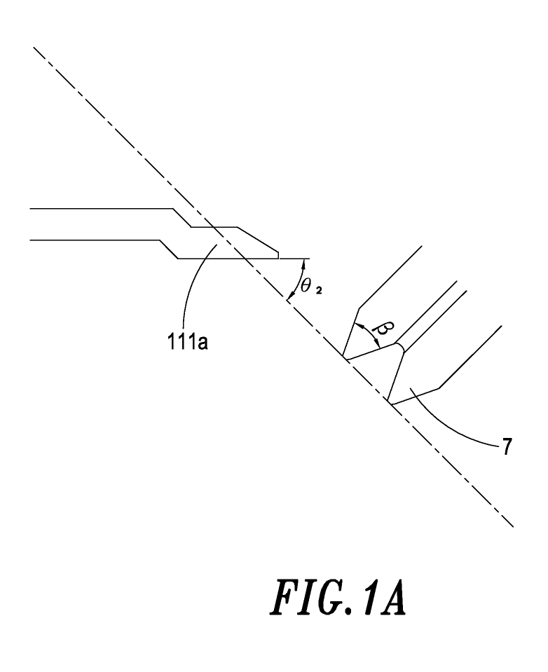

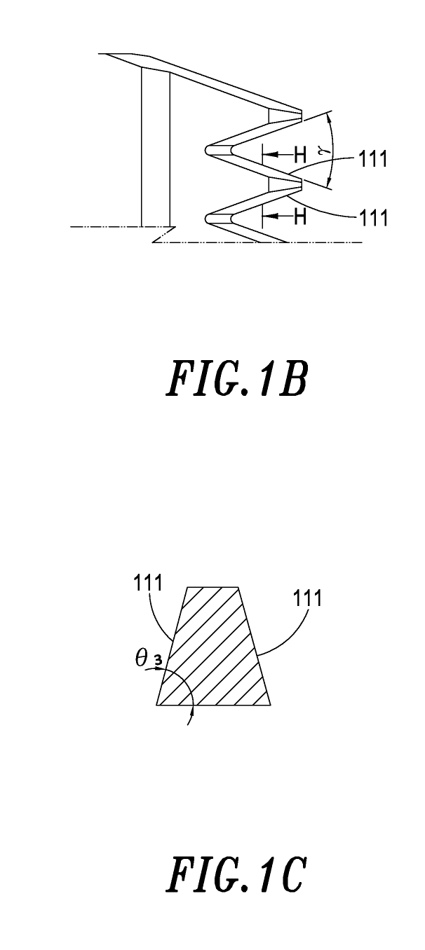

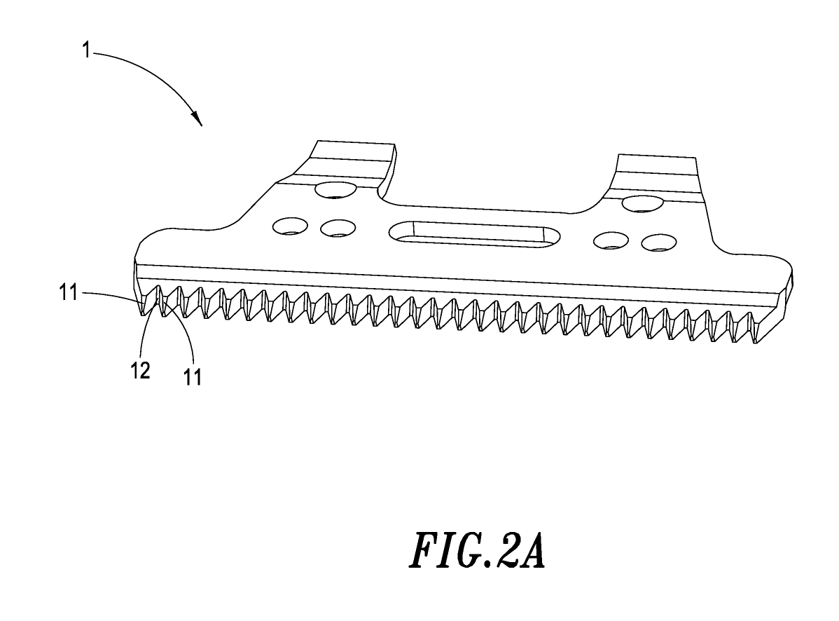

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

Refer now to FIGS. 4, 5 and 6, wherein a structure view for a non-machined blade, a structure view for a partially machined blade as well as a structure view for a completely machined blade used in the blade set of the hair clipper blade and a manufacture method thereof according to the present invention are respectively shown. In the present invention, although a movable blade is exemplified, it should be noticed that the hair clipper blade set structure and the manufacture method thereof disclosed in the present invention can be also applied to a fixed blade. In the present embodiment, it initially utilizes a stamping equipment (not shown) to punch out a movable blade 4 having plural round through holes 411, in which the round through holes 411 are located on the flat plane 41 at the front end of the movable blade 4, and the movable blade 4 fabricated in this way so far is referred as a semi-processed blade.

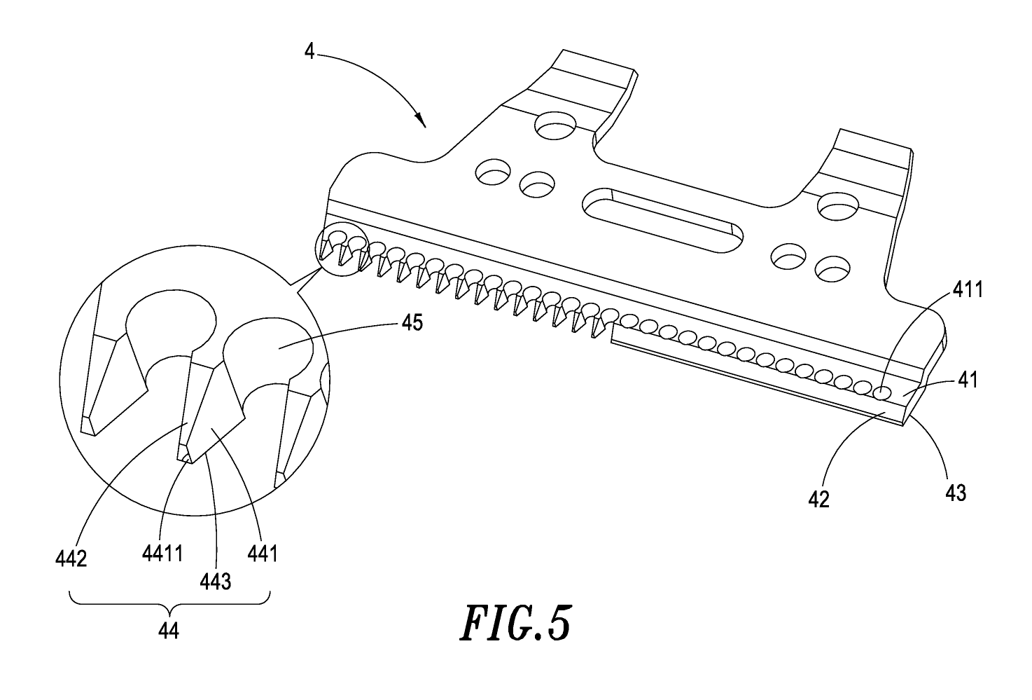

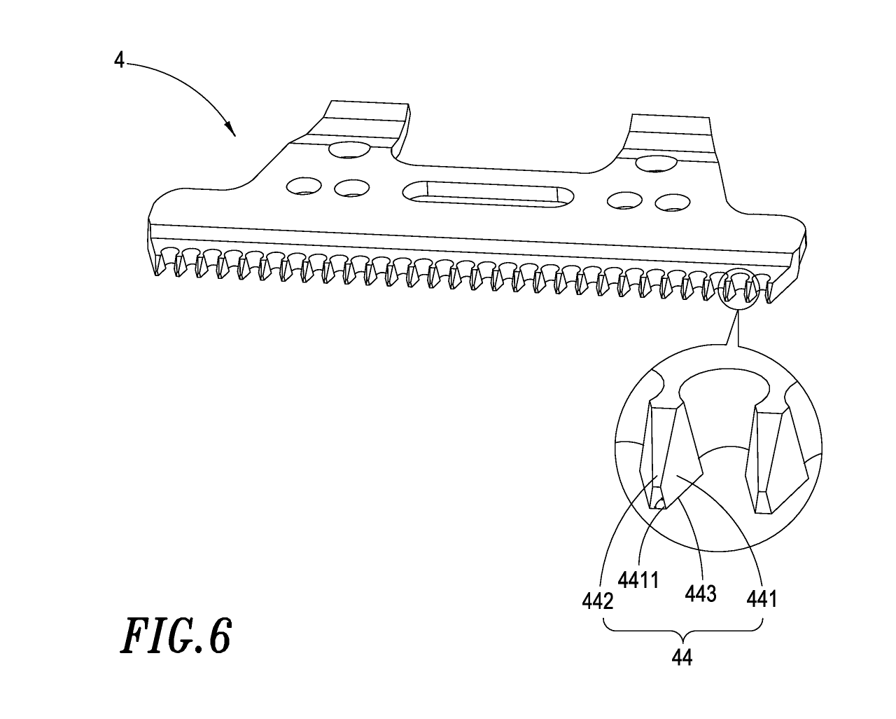

Next, from FIGS. 5 and 6, it can be observed that it then uses a grinding wheel (not shown) to perform cut machining at the front end 42 of the movable blade 4 in the semi-processed blade toward the direction of the round through hole 411 so as to form multiple tooth units 44 in a row. The edge part 441 located on the side of the tooth unit 44 is formed by means of the grinding wheel via cutting operations, and since the grinding wheel cuts toward the round through hole 411, a groove hole 45 can be produced between each two corresponding edges 441.

Moreover, since there is a front end 42 on the top plane of the front end in the body of the movable blade 4 in the semi-processed blade and there is a plane 43 on the bottom plane of the front end, consequently, the top plane of the front end on the tooth unit 44 cut by the grinding wheel during the machining process is also an inclined plane 442, and the bottom plane of the front end is also a plane 443, so that, after having completed the cutting process, a sharp angle 4411 can be naturally created at the edge part 441. Therefore, the manufacture processes of the present invention require simply two steps of stamping and grinder cutting. Furthermore, the groove hole 45 is also tapered (not shown) such that it is possible to cut off hair when the movable blade 4 clips with a fixed blade no matter by the sharp angle 4411 of the edge part 441 or otherwise the tapering of the groove hole 45, and the tapering of the groove hole 45 makes the bottom of groove hole 45 become a sharp angle enabling the cutting function.

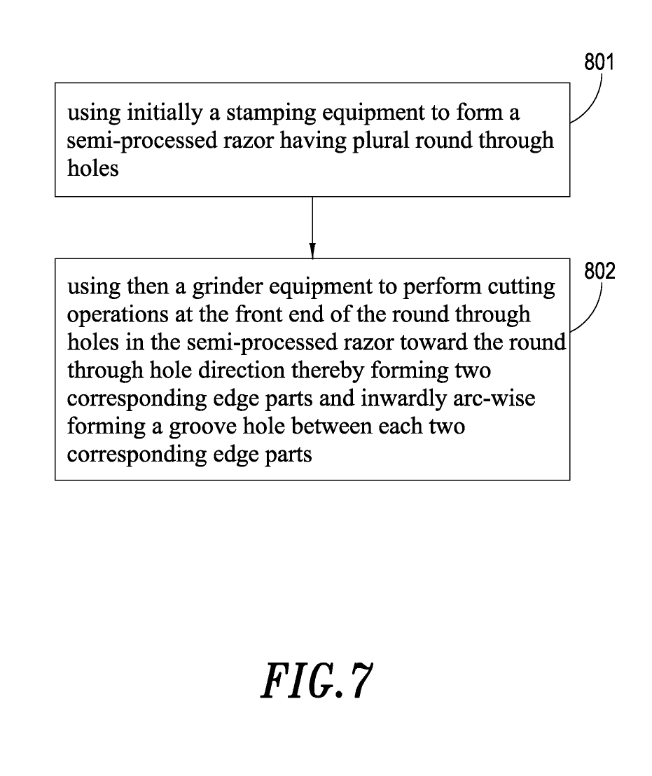

FIG. 7 shows the manufacture method for a movable blade according to the present invention, the processes thereof being summarized as below:

(1) using initially a stamping equipment to form a semi-processed razor having plural round through holes (801); and

(2) using then a grinding wheel to perform cutting operations at the front end of the round through holes in the semi-processed blade toward the round through hole direction thereby forming two corresponding edge parts and inwardly arc-wise forming a groove hole between each two corresponding edge parts (802).

From the aforementioned processes, it can be appreciated that, being different from fabrication processes for the conventional V-shaped tooth groove, the present invention presets the groove hole 45 at the bottom of the tooth unit 44 so that, during the machining operations, the cutting path of profile machining required for forming the tooth unit 44 can be shortened thereby reducing the cut machining workload, enhancing machining efficiency and lessening grinder tooling consumptions.

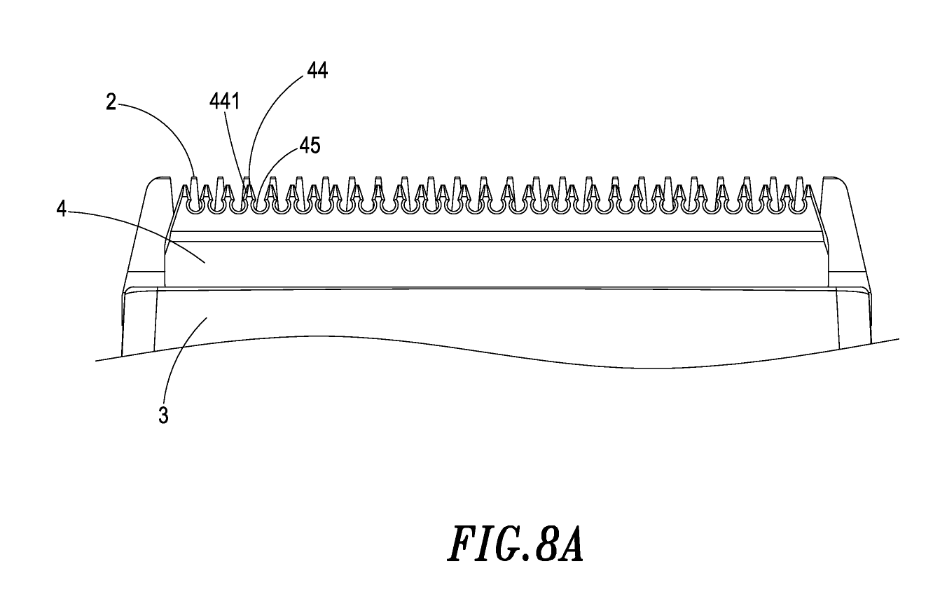

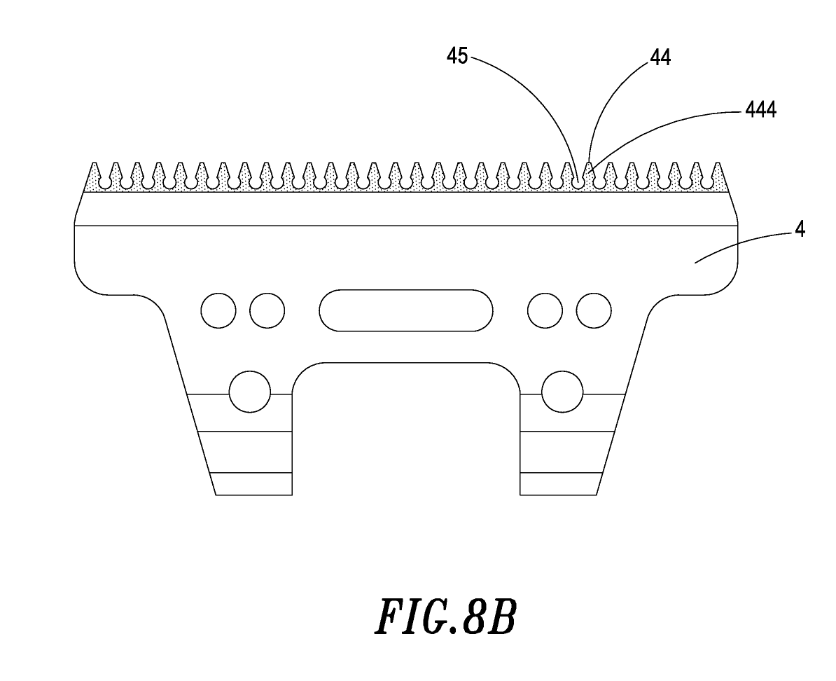

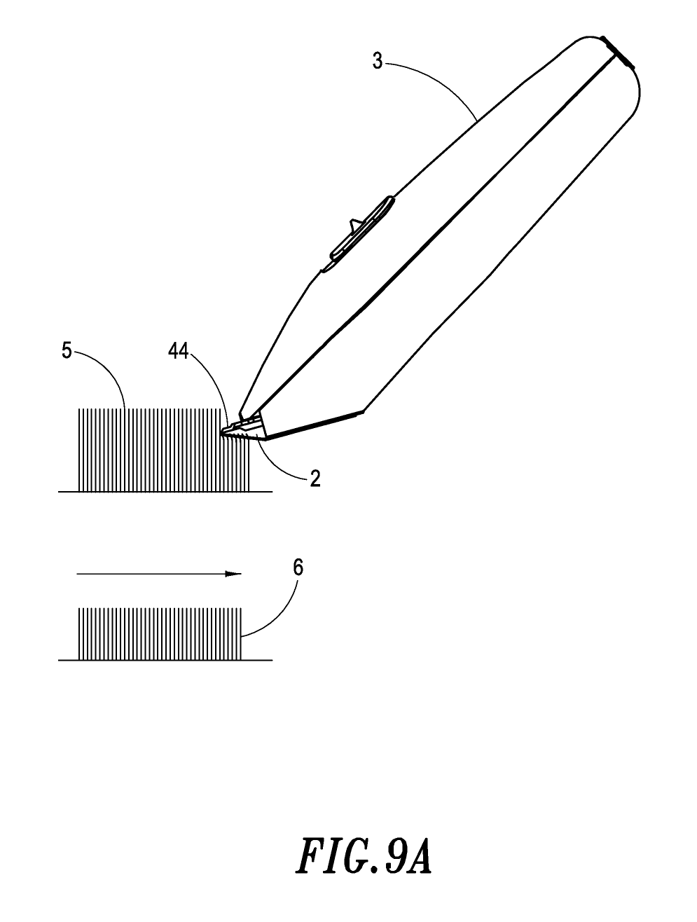

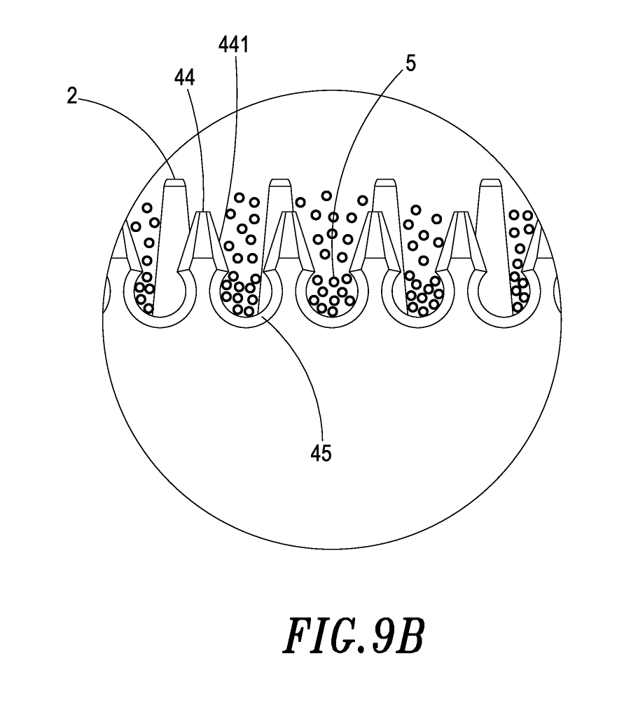

In addition, referring to FIGS. 8A, 8B, 9A and 9B, when the movable blade 4 and the fixed blade 2 are overlapped together in combination and installed onto a hair clipper 3 as shown, the following features can be provided:

(1) The groove hole 45 can effectively reduce the mutually jamming condition because of entering hair 5, the hair 5 sliding into the tooth groove during hair trimming will not be reversely pushed out due to squeezing, therefore, the trimmed hair 6 can be relatively smooth and even.

(2) It allows the hair 5 entering into the groove hole 45 to keep its original loose status, so that, compared with condensed hair strings caused by the narrower bottom end in a traditional V-shaped tooth groove, hair trimming can be more convenient thereby increasing trimming efficiency.

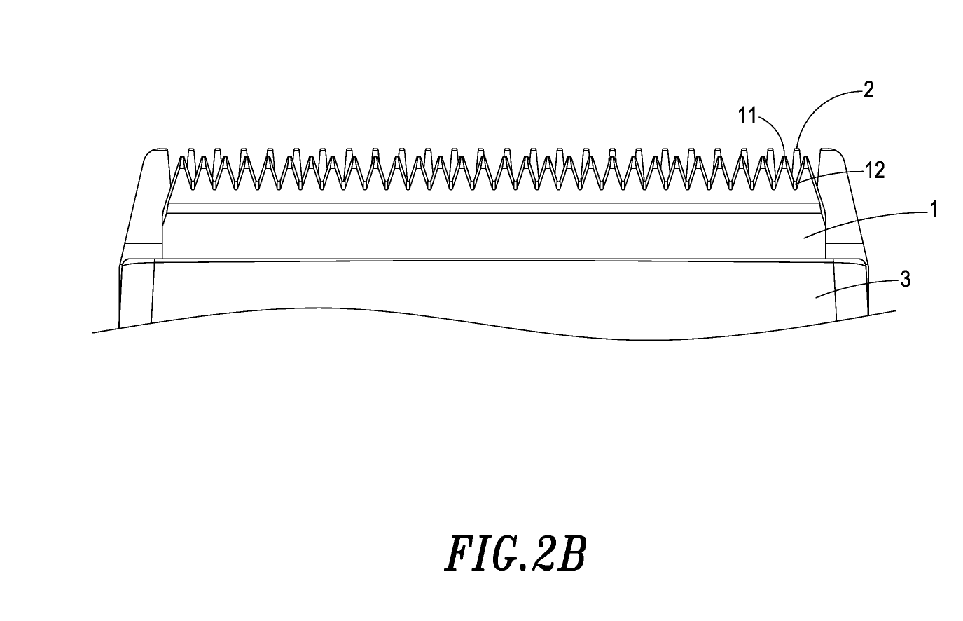

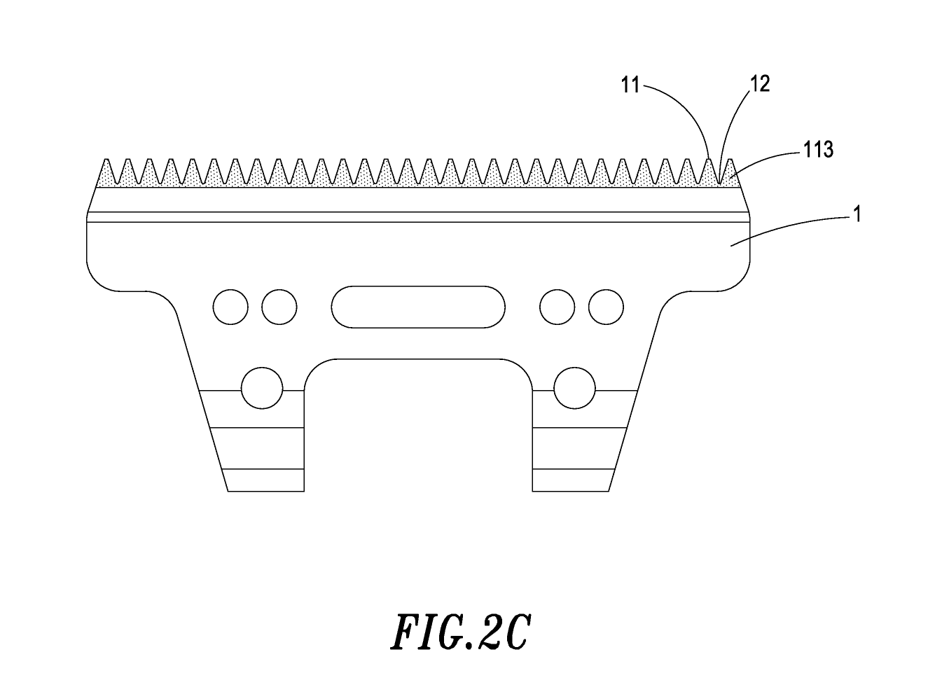

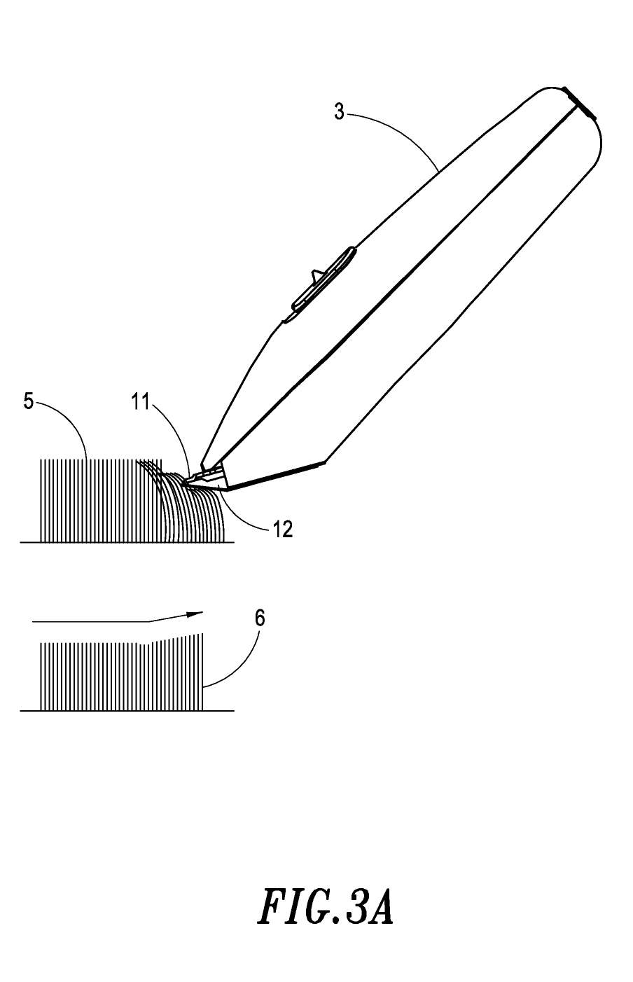

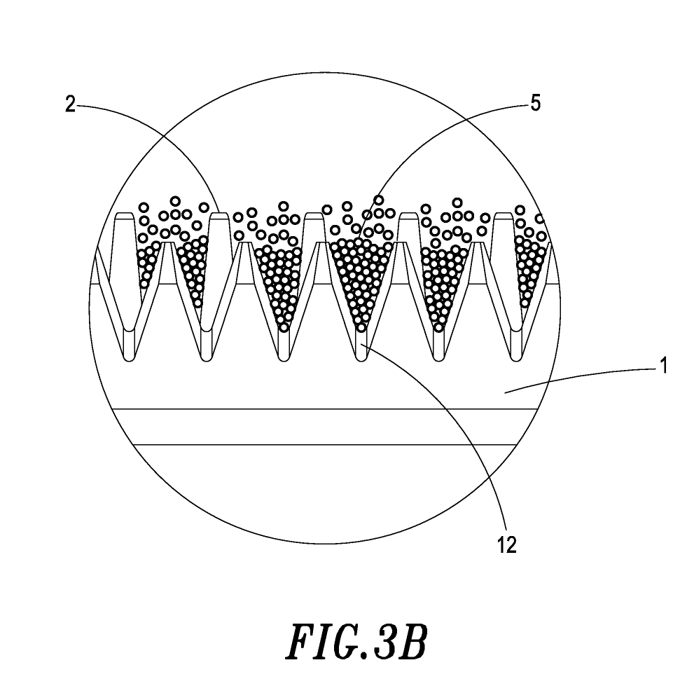

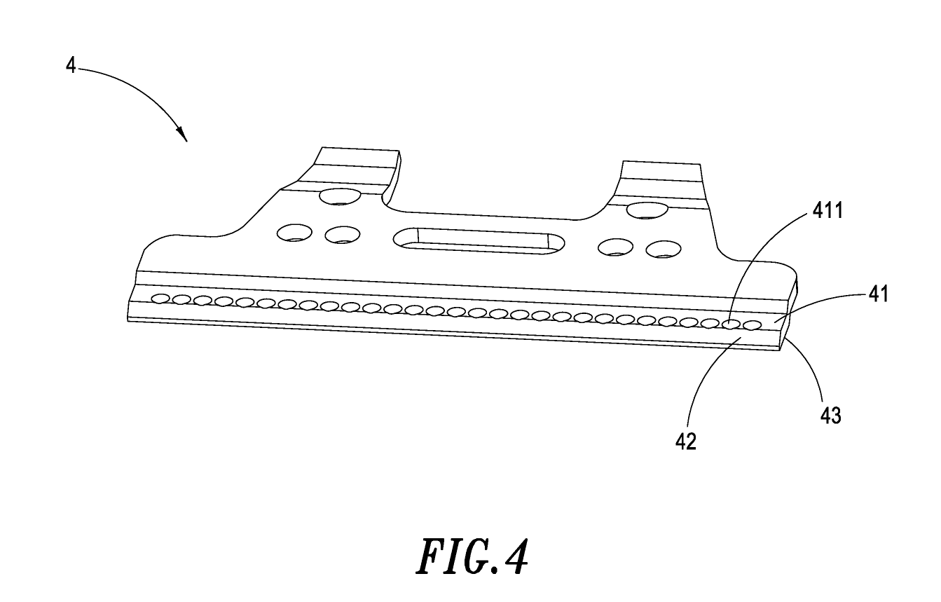

(3) Based on the present invention shown in FIG. 8B and the prior art shown in FIG. 2C, by comparing the contact plane 444 for overlapping onto the fixed blade 2 in the present invention with the contact plane 113 for overlapping the conventional comb-like teeth 11 onto the fixed blade 2, it can be seen that a V-shaped tooth groove 12 is configured between the conventional comb-like teeth 11, but the tooth unit 44 of the present invention includes the groove hole 45, and since the groove bottom of the groove hole 45 has an arc-wise recess, compared with the conventional V-shaped tooth groove 12, the groove hole 45 of the present invention can reduce the contact area to the blade such that friction resistance can be effectively lessened in order to decrease electric power consumptions; meanwhile, the temperature elevation because of frictions can be also lowered so as to eliminate the blade heating problem.

In comparison with other conventional technologies, the hair clipper blade and a manufacture method thereof according to the present invention provides the following advantages:

1. The present invention proposes to initially perform the stamping operation on thick, solid metallic plate materials and then the cutting operation, such that a groove hole can be formed at the bottom of the tooth unit, so that, upon trimming hair, the groove hole can effectively reduce the hair jamming condition because of entering hair such that the hair sliding into the tooth groove during hair trimming will not be reversely pushed out due to squeezing. Therefore, the trimmed hair can be comparatively smooth and even. Additionally, it allows the hair entering into the groove hole to keep its original loose status, so that, compared with condensed hair strings caused by the narrower bottom end in a traditional V-shaped tooth groove, hair trimming can be more convenient thereby increasing trimming efficiency.

2. The groove hole of the present invention can reduce the contact area to the blade such that friction resistance can be effectively lessened in application so as to decrease electric power consumptions; meanwhile, the temperature elevation because of frictions can be also lowered thereby eliminating the blade heating problem.

Although the present invention has been disclosed through the detailed descriptions of the aforementioned embodiments, such illustrations are by no means used to restrict the present invention. Skilled ones in relevant fields of the present invention can certainly devise any applicable alternations and modifications after comprehending the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A hair clipper blade, comprising: plural tooth units, in which both the two sides of the front end in each tooth unit include an edge part, and a groove hole is inwardly arc-wise formed between the bottom end of each side in each tooth unit and the bottom end in the adjacent tooth unit.

2. The hair clipper blade according to claim 1, wherein the edge part has a sharp angle.

3. The hair clipper blade according to claim 1, wherein the groove hole is further tapered such that the bottom part of the groove hole has a sharp angle enabling the cutting function.

4. The hair clipper blade according to claim 1, wherein the groove hole is a round groove.

5. A manufacture method for a hair clipper blade, comprising:
using initially a stamping equipment to form a semi-processed blade having plural round through holes; and
using then a grinding wheel to perform cutting operations at the front end of the round through holes in the semi-processed blade toward the round through hole direction thereby forming two corresponding edge parts and inwardly arc-wise forming a groove hole between each two corresponding edge parts.

6. The manufacture method for a hair clipper blade according to claim 5, wherein the edge part has a sharp angle.

7. The manufacture method for a hair clipper blade according to claim 5, wherein the groove hole is further tapered such that the bottom part of the groove hole has a sharp angle enabling the cutting function.

8. The manufacture method for a hair clipper blade according to claim 5, wherein the groove hole is a round groove.
